(19) United States
(12) Patent Application Publication
(10) Pub. No.: US 2009/0260843 A1
(43) Pub. Date: Oct. 22, 2009

(54) HIGH VOLTAGE BUSHING

(75) Inventors: Christer Tornkvist, Stromsholm (SE); Uno Gafvert, Vasteras (SE)

Correspondence Address: VENABLE LLP, P.O. BOX 34385, WASHINGTON, DC, 20043-9998, US

(73) Assignee: ABB RESEARCH LTD., Zurich (CH)

(21) Appl. No.: 12/439,539

(22) PCT Filed: Aug. 30, 2007
(86) PCT No.: PCT/SE2007/050600

§ 371 Date: Mar. 1, 2009

(30) Foreign Application Priority Data
Aug. 31, 2006 (SE) 0601787-5

(51) Int. Cl. H01B 9/06

(52) U.S. Cl. 174/8

(57) ABSTRACT

A high voltage bushing including a metal part provided with a resistive layer.

### FIELD OF INVENTION

The present invention relates generally to high voltage bushings and more particularly to a high voltage bushing with improved protection against partial discharges.

### BACKGROUND

It is known that electrical equipment and devices, such as high voltage transformers, are usually equipped with bushings, which are suitable to carry current at high potential through a grounded barrier, e.g. a transformer tank or a wall.

Conventional bushings are constituted by an insulator made of ceramic or composite material, which is provided with sheds and is generally hollow. The voltage grading can be obtained with or without a condenser body through which the electrical conductor passes.

An example of a bushing 1 for wall mounting will now be described with reference to FIG. 1 showing the overall structure of the bushing, and FIG. 2 showing a sectional view of the bushing mounted to a wall.

A high voltage conductor 2 extends through the center of a hollow gas filled bushing insulator 4 that forms a housing around the high voltage conductor. A wall flange 6 is provided to connect the housing of the bushing to ground through a wall. The high voltage conductor is provided with a contact 8, 10 in both ends thereof.

A wall 12 is shown in FIG. 2, in which the bushing 1 is mounted by means of the wall flange 6. This figure shows a so-called throat shield or voltage grading shield 14 provided inside the hollow bushing insulator 2 at and around the portion of the bushing going through the wall 12. This shield, which is made of a suitable metal, such as aluminum, accomplishes grading of the electrical field in the bushing and is used instead of a condenser core.

In gas filled high voltage bushings, dust or dirt can become a problem if the dust particles generate partial discharge when hitting a metallic electrode, such as the voltage grading shield.

### SUMMARY OF THE INVENTION

An object of the present invention is to provide a gas filled high voltage bushing wherein the risk for partial discharge is reduced compared to prior art bushings.

The invention is based on the realization that highly dielectrically metal parts in a bushing can be provided with a resistive layer, allowing slow and controlled discharge of particles hitting the surface thereof.

According to a first aspect of the invention a high voltage bushing for use with a high voltage device is provided, the high voltage bushing comprising a metal part provided in a gas filled hollow insulator housing and a voltage grading metal shield provided in the insulator housing; the bushing being characterized in that at least a portion of the surface of the metal part is provided with a layer having a resistivity in the range of 10⁸-10¹⁴Ωm.

According to a second aspect of the invention a high voltage device comprising such a bushing is provided. With the inventive bushing, slow and controlled discharge of particles hitting the surface of the metal part is achieved. This in turn reduces or even eliminates partial discharge due to dust or dirt inside the insulator housing of the bushing.

In a preferred embodiment, the resistive layer comprises a polymeric material.

In another preferred embodiment, the resistive layer comprises a ceramic material.

In a further preferred embodiment, the resistive layer is provided on an outer end portion of the metal part, this portion being highly stressed.

Further embodiments are defined in the dependent claims.

### BRIEF DESCRIPTION OF DRAWINGS

The invention is now described, by way of example, with reference to the accompanying drawings, in which:

FIG. 1 is an overall view of a prior art high voltage bushing;

FIG. 2 is a sectional view of the bushing of FIG. 1 mounted extending through a wall; and

FIG. 3 is a partially cut-away view of a voltage grading shield and a wall flange of a bushing according to the invention.

### DETAILED DESCRIPTION OF A PREFERRED EMBODIMENT OF THE INVENTION

In the following a detailed description of a preferred embodiment of the present invention will be given. In this description, the term “high voltage” will be used for voltages of 10 kV and higher. Today, the upper limit in commercial high voltage devices is 800 kV but even higher voltages, such as 1000 kV or more, are already built or envisaged in the near future.

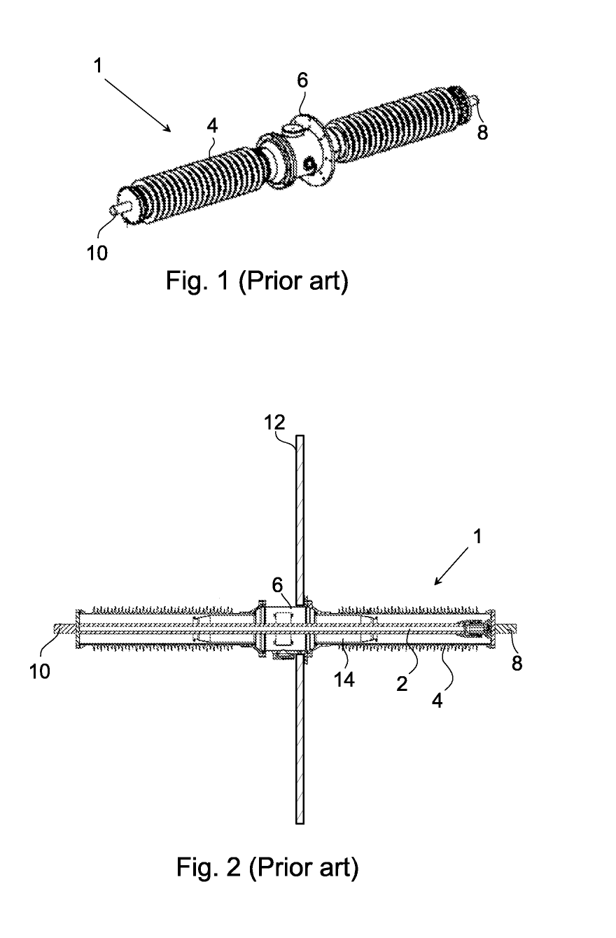

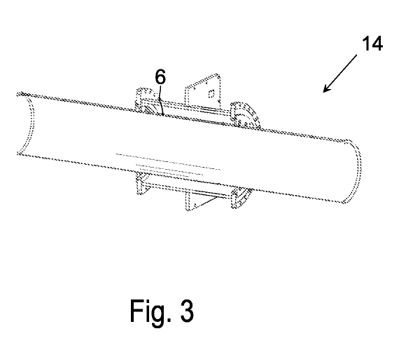

The present invention is applicable to the general description of the high voltage bushing given in the background section with reference to FIGS. 1 and 2 and reference will in the following be made to these figures. However, reference will now be made to FIG. 3, showing a partially cut-away perspective view of a metal part in the form of a voltage grading shield 14, including a wall flange 6.

The voltage grading shield 14 is essentially cylindrical. The main portion of the shield 14 is made of some suitable metal, such as aluminum. A resistive layer is provided at least on a portion of the surface of the shield, preferably on highly dielectrically stressed surfaces, such as at the end portions of the voltage grading shield. By “resistive” is in this context be construed a layer having a controlled resistivity between 10⁸-10¹⁴Ωm allowing slow and moderate discharge of particles hitting the surface thereof. In one embodiment, the resistive layer comprises a ceramic material including aluminum oxide. I the case the resistive layer comprises aluminum oxide, this layer is preferably created by anodizing aluminum to a thickness of 10-1000 μm.

In another embodiment, the resistive layer comprises a polymeric base material, such as epoxy, polyurethane, or Teflon. This base material can be filled or unfilled. The resistive layer preferably has a thickness of 10-1000 μm.

A preferred embodiment of a high voltage bushing has been described. A person skilled in the art realizes that this could be varied within the scope of the appended claims. Thus, although the metal part provided with a resistive layer has been described as a voltage grading shield, it is realized that other metal parts in the hollow insulator housing of a bushing, such as flanges or conductors, also fall within the definition of metal part.

Although the bushing according to the invention has been described mounted through a wall, is will be appreciated that bushings for assembly to a high voltage device, such as a transformer, reactor, breaker, generator, or other device finding an application in high voltage systems are also covered by the inventive idea.

1. A high voltage bushing comprising:
a high voltage conductor provided in a gas filled hollow insulator housing; and
a metal part provided in the insulator housing;
wherein at least a portion of a surface of the metal part is provided with a layer having a resistivity in the range of 10⁸-10¹⁴Ωm.

2. The high voltage bushing according to claim 1, wherein the layer comprises a ceramic material.

3. The high voltage bushing according to claim 1, wherein the layer comprises a polymeric base material.

4. The high voltage bushing according to claim 3, wherein the polymeric base material is any of epoxy, polyurethane, and Teflon.

5. The high voltage bushing according to claim 1, wherein the layer comprises of aluminum oxide.

6. The high voltage bushing according to claim 1, wherein the layer has a thickness in the range of 10-1000 μm.

7. The high voltage bushing according to claim 1, wherein the resistive layer is provided on an outer end portion of the metal part.

8. A high voltage device comprising
a high voltage bushing comprising a high voltage conductor provided in a gas filled hollow insulator housing, and a metal part provided in the insulator housing, wherein at least a portion of a surface of the metal part is provided with a layer having a resistivity in the range of 10⁸-10¹⁴Ωm.
